(19) United States
(12) Patent Application Publication
(10) Pub. No.: US 2006/0039833 A1
(43) Pub. Date: Feb. 23, 2006

(54) Biological specimen collection, transportation, and dispensing system

(76) Inventor: Peter A.K. Yong, Torrance, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/191,300

(22) Filed: Jul. 28, 2005

Related U.S. Application Data
(60) Provisional application No. 60/598,812, filed on Aug. 4, 2004.

(51) Int. Cl. G01N 1/10; G01N 1/14

(52) U.S. Cl. 422/102; 73/864.51; 73/864.91

(57) ABSTRACT

A body fluid collecting, transporting, and dispensing system includes a body fluid collecting receptacle and a handle for supporting the receptacle in a fluid collection position. The handle includes a fluid sample chamber in fluid communication with the receptacle to receive a sample of the body fluid and the handle is further removable from the receptacle for transport and dispensing of the body fluid sample.

The present application claims priority from U.S. Provisional Patent Application Ser. No. 60/598,812 filed Aug. 4, 2004. This application is to be incorporated herewith by its specific reference thereto.

The present invention relates generally to the field of medical analysis devices, and more particularly to the field of body fluid collection devices, and still more particularly to body fluid collecting, storage, transporting, and dispensing systems, for blood, saliva, sperm, pus, and even more particularly to urine collecting, transporting and dispensing systems.

Urine analysis is one of, if not the, most common medical lab analysis procedures. The present inventor understands that many millions of such urine analysis procedures are performed each week in the United States alone.

Such urine analysis procedures typically involve having a patient urinate into a hand held cup-like receptacle and then sending (that is, transporting) the entire urine-containing receptacle to an appropriate laboratory for analysis, even though only a small amount of the contained urine is required for analysis. The end result is that for any particular laboratory, a relatively large number of such urine collecting receptacles, representing a large volume of space and often requiring being kept cool, must be transported to the laboratory, even though only a small percentage (10-15 ml) of each urine sample is needed for the analysis. Moreover, the handling of the cumulative large quantity of urine contained in the many receptacles can present health risks to health care personnel, because of the possibility of hepatitis virus, AIDS virus, chlamydiaT. and other pathogens being present in the urine samples, and the possibility of urine spillage. Which can soil the users hand.

In addition, abusive drug testing of individuals for employment purposes and civil or criminal matters is widely performed, and improvements to the collecting and testing of urine samples and the collecting and transporting of back-up urine samples are needed. This applies to other on-site testing such as IVD analytical testing for UTI, diabetes, pregnancy, ovulation, HIV among others.

It is thus a principal objective of the present invention to provide a urine (or other bodily fluid) containing, transporting, and dispensing system that overcomes the above-mentioned problems heretofore encountered in existing urine collection and transporting procedures.

### SUMMARY OF THE INVENTION

A body fluid collecting, transporting, and dispensing system in accordance with the present invention generally includes a body fluid collecting receptacle and, in combination therewith, an ergonomic handle for supporting the receptacle in a fluid collection position. The handle includes a fluid collecting and storage sample chamber which is in fluid communication with the receptacle to receive a sample of the body fluid.

Because the handle is removable from the receptacle, it provides for safe transport and dispensing of the body fluid sample. In other words, the original collecting receptacle can be sealed and disposed while a fluid sample is securely kept and sealed and then separately transported and dispensed at a receiving area (lab).

More particularly, in accordance with the present invention, the handle may include a sample withdrawing plunger with a head disposed in the chamber and a tip for withdrawing a fluid sample through a fitting in the receptacle. Preferably, the plunger is removable from the head and handle and the system further comprises a tip cap to facilitate safe transport of the handle containing the fluid sample. Multiple reusable plungers may be provided and used at all receiving area or labs.

In one embodiment, the present invention the fluid sample chamber includes a rotatable stopper at an end opposite of the tip and the fluid chamber includes an air vent aperture.

This aperture is disposed at a position exposable by rotation of the stopper in order to enable dispensing of the fluid sample through the tip with the cap removed.

In order to improve efficiency of fluid collection, the receptacle may include a displacement member which is fixed within the receptacle and disposed at a position which raises a fluid sample level within the receptacle up to the fitting.

In this manner, when a patient can only excrete a small quantity of fluid sample it still can be effectively collected by the receptacle while at the same time providing a sufficient size fluid sample to the collection handle.

This feature is available for all of the embodiments in accordance with the present invention which includes several handle configurations.

For example, in another embodiment of the present invention, the handle includes a squeezable bulb disposed at an end of the chamber to withdraw the fluid into the chamber.

A sealable and unsealable port in the chamber may be provided at a spaced apart distance from the tip with unsealing of the port enabling dispensing of the fluid sample through the tip. This port operates in a manner similar to the air vent aperture hereinabove described.

In one sub-embodiment, a separable tape member is provided for sealing the port and in another sub-embodiment, a stretchable elastic member is provided for sealing the port along with a mechanism for stretching the elastic member to open the port, when desired, for dispensing of the fluid sample.

The fluid sample chamber may include a tip for withdrawing the fluid sample as hereinabove noted through a fitting in the receptacle and further may include a moveable center tube for introducing the fluid sample into the chamber through an end thereof disposed at a spaced apart distance from the tip.

This end is disposed below the squeezable bar bulb and provides venting for the fluid sample drawn into the chamber.

In that regard, a colored float may be disposed in the chamber for indicating a level of fluid sample in the chamber, thus providing an elderly user an indication of a sufficient sample being collected.

In this embodiment, a cap is provided for sealing the tip and for moving the center to and from the first position to the second position. In order for this function to occur, the cap includes structure including the two opposing cavities of different depths. A first cavity enables sealing of the tip without engagement of the center tube and thus no displacement thereof. The second cavity enables sealing of the tip with engagement and movement of the center tube to the second position.

With the center tube moved to the second position, an egress opening is unsealed thereby enabling later discharge, of the sample fluid through the tip.

Further, in accordance with the present invention the bulb may be removable from the chamber and a closable lid may be provided to cover a top of the chamber. The lid may include a puncturable portion, which enables removal of the fluid sample by a syringe or needle by a specialized IVD analytical machine.

All of the embodiments of the present invention provide for the collection, storage, transportation, and dispensing of samples, such as urine, sperm, saliva, blood with absolutely no human contact therewith. Further, the possibility of human contact is eliminated in accordance with the present invention and therefor provides a closed or self-containing system for safe and hygienic fluid sample procedures.

The present invention may further provide advantage by including a solid active reagent disposed in the chamber for dissolution by the fluid sample or a liquid active reagent disposed in a chamber for mixing with the fluid sample. Any number of active reagents may be utilized for conventional pre-treatment of fluid body samples.

In another embodiment of the present invention, a prevacuated tube and holder, which acts as a handle, is provided for drawing the sample from the receptacle.

In yet another embodiment of the present invention, the fluid sample chamber may initially include a vacuum for drawing the sample from the receptacle and a plunger head may be disposed in a chamber with a removable top chamber seal along with a plunger attachment of the head for dispensing of the fluid sample from the chamber through a tip.

A still further embodiment of the present invention provides for a wick to introduce fluid samples into the chamber by lateral flow mechanism. This embodiment is particularly suited for enabling the use of reagent strips which are visible through a chamber window for indicating the presence of at least one component of the fluid sample. In this manner, a prescreening of the sample may be provided by the present invention.

With the use of a rectangular chamber, a plurality of reagent strips may be disposed against each rectangular phase for indicating the presence of a plurality of specific components of the fluid sample. For example, if three reagent strips are utilized on the each rectangular face, a total of twelve preliminary tests may be utilized in accordance with the present invention. Alternatively, the reagent strips may be wetted by flooding or dipping.

In yet another embodiment of the present invention, the receptacle may include at least one reagent strip disposed at the bottom thereof which is visible therethrough for performing the preliminary tests. In addition, this embodiment facilitates the use of a conventional copier machine for recording the results of the preliminary tests provided by the test strips.

### BRIEF DESCRIPTION OF THE DRAWINGS

The present application can be more readily understood by consideration of the following detailed description when taken in conjunction with the accompanying drawings, in which:

FIG. 1 is a cross sectional view of a body fluid collecting, transporting, and dispensing system in accordance with the present invention generally showing a body fluid collecting receptacle, cap therefor, along with a handle including a fluid sample chamber for receiving a sample of body fluid disposed in the receptacle, not shown in FIG. 1, the handle being removable from the receptacle for transport and dispensing of the body fluid sample;

FIG. 2 is an exploded cross sectional view of the handle as shown in FIG. 1 generally illustrating a sample withdrawing plunger with a head disposed in the chamber and a tip for withdrawing the fluid sample through a fitting in the receptacle along with a cap and a plunger stopper;

FIG. 3 is a plan view of the plunger stopper illustrated in FIG. 2;

FIG. 4 is a view of the system as shown in FIG. 1 illustrating collection of fluid sample in the receptacle along with a displacement member fixed within the receptacle for raising a fluid sample level within the receptacle, to the fitting;

FIG. 5 is a view similar to that in FIG. 4 illustrating the withdrawal of a fluid sample into the handle via the fitting;

FIG. 6 is a view similar to FIG. 5 illustrating removal of the plunger from the head and handle with the head remaining a level above the venting aperture of the handle;

FIG. 7 is a view similar to that shown in FIG. 6 showing the installation of the cap for sealing the handle tip;

FIGS. 8, 9, and 10 illustrate the use of a rotatable stopper at an end of the chamber for opening of an aperture to enable venting and dispensing of fluid sample through the tip with the cap removed without further use of a plunger;

FIGS. 11-15 illustrate the efficiency provided by the displacement member which enables the collection of full sample from the receptacle through the tilting of the receptacle handle, as illustrated;

FIGS. 16-18 illustrate the procedure for collection, storage, and dispensing of a fluid within the handles;

FIGS. 19-28 illustrate another embodiment of the present invention for a handle includes a squeezable bulb disposed at an end to the chamber to withdraw fluid sample into the chamber along with a center tube and float arrangement as hereinafter described in greater detail;

FIGS. 29-35 illustrate an embodiment of the present invention illustrating a removable or separable tape member for sealing and exposing the port;

FIGS. 36-43 illustrate the utilization of a stretchable elastic member for sealing the port and a mechanism for stretching the elastic member to open the port, as hereinafter described in greater detail;

FIGS. 44-46 illustrate the use of a removable bulb and lid arrangement along with preloading the chamber with solid or liquid active reagents for mixing with the fluid in the chamber, as hereinafter described in greater detail;

FIGS. 47-49 illustrate an embodiment of the present invention further utilizing a lid having a puncturable portion for enabling removal of the fluid sample by a syringe or needle in a specialized analytical machine;

FIGS. 50-55 illustrate yet another embodiment of the present invention which receives a prefilled syringe for active agent using a calibrated storage chamber along with further features such as a removable wing and a security sealable top and tip for attachment of a plunger in accordance with the present invention;

FIGS. 56-59 illustrate yet another embodiment of the present invention in which the handle chamber includes a wick for introducing fluid chamber into the chamber, in this embodiment at least one reagent strip is visible through a chamber window for indicating the presence of at least one specific component of the fluid sample, multiple simultaneous tests being performable through the use of a triangular or rectangular shaped chamber;

FIGS. 60-69 show yet another embodiment of the present invention utilizing the components hereinabove illustrated and further showing at least one reagent strip disposed on a bottom of the receptacle and visible therethrough and recordable by a conventional copier as illustrated specifically in FIG. 68;

FIG. 70 shows another embodiment of the present invention utilizing a vacuum tube holder as a handle with a vacuum chamber for drawing the sample from the receptacle along with a mechanism for introducing fluid sample into the vacuum file which is removable from the handle along with a receptacle wall configuration for drawing fluid sample from a bottom of the receptacle;

FIGS. 71-72 shows a dual syringe embodiment of the present invention;

FIGS. 73-74 show an alternative embodiment of a dual tube holder in accordance with the present invention;

FIGS. 75-76 show yet a further embodiment of a handle in accordance with the present invention utilizing a bulb and testing strips which may be wetted by flooding and dipping;

FIGS. 77-79 show a handle embodiment utilizing a removable plunger to create a vacuum in the handle for withdrawal of a fluid sample; and

FIGS. 80-81 show a umbilical cord blood collecting, storage, transportation, and dispensing system particularly suitable for umbilical cords blood and fetal stem cells.

### DETAILED DESCRIPTION

Throughout the specification common reference numbers refer to identical or substantially similar elements, as hereinbelow described.

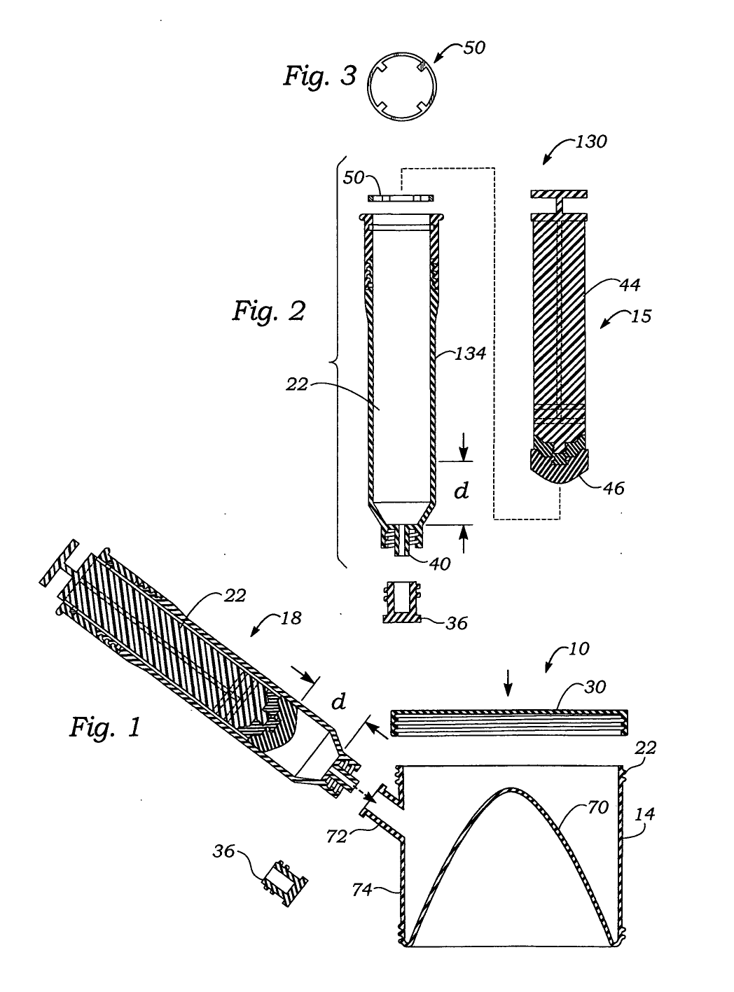

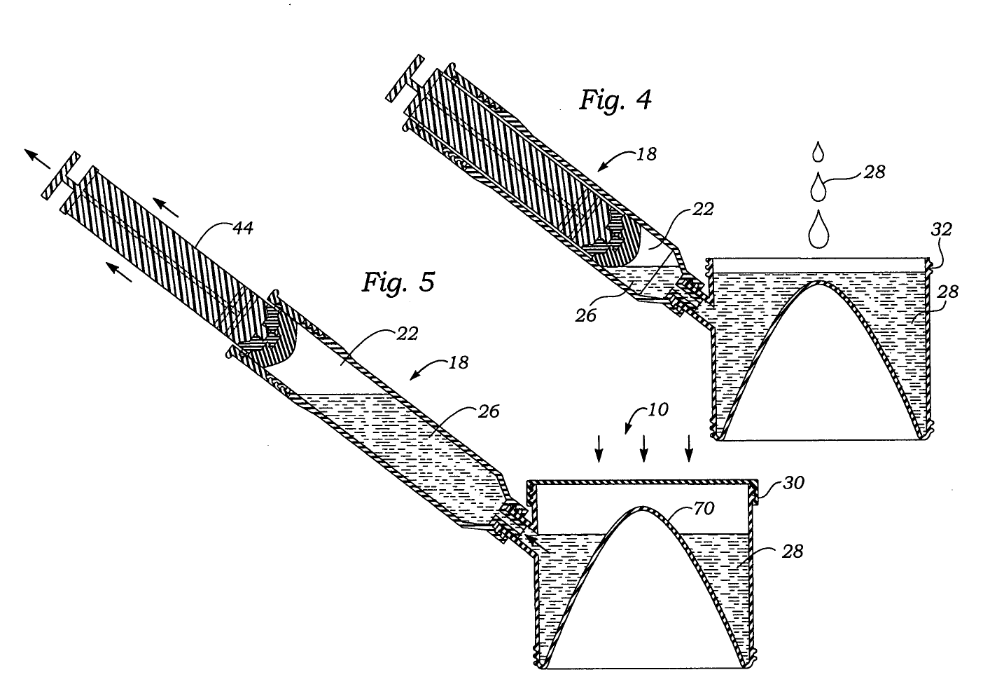

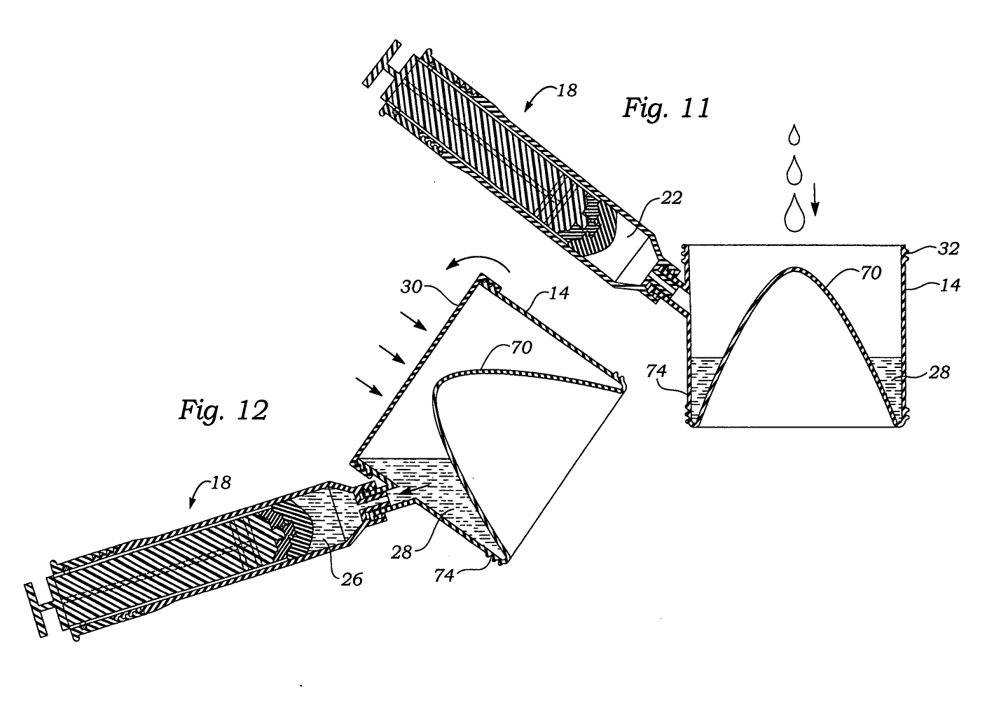

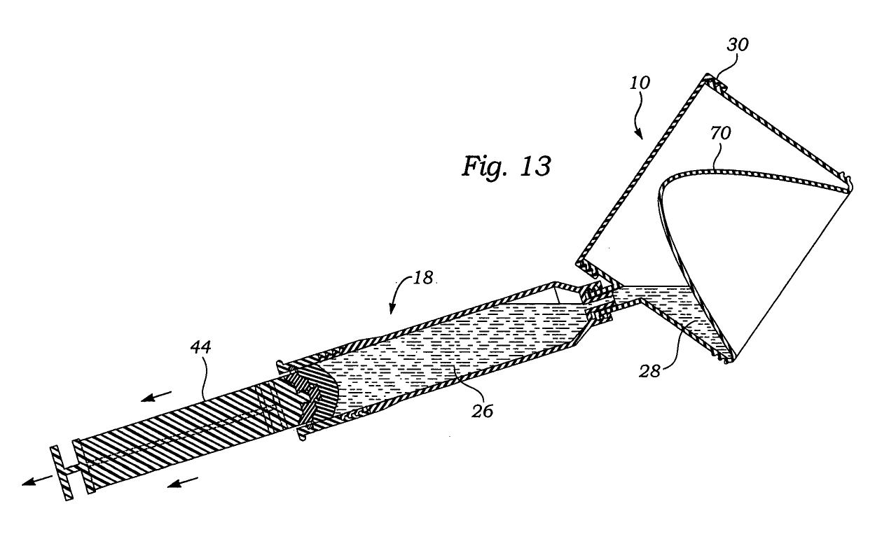

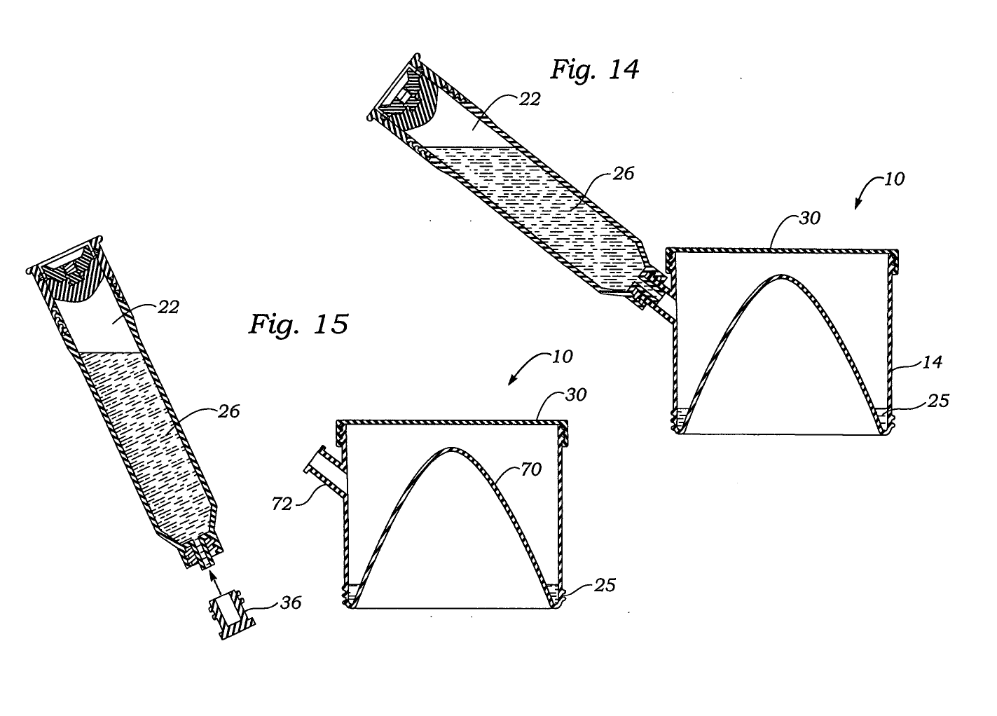

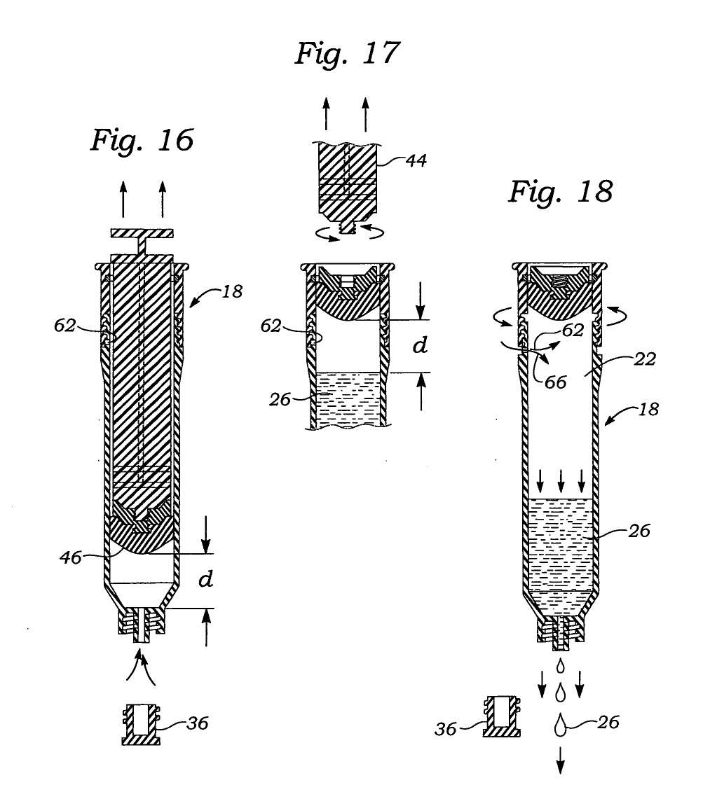

With reference to FIGS. 1-18, there is shown a body fluid collecting, storage, transporting, and dispensing system 10 generally including a body fluid collecting receptacle 14 and a handle 18 supporting the receptacle 14 in a fluid collection position as most specifically shown in FIG. 4.

As illustrated, the handle 18 includes a fluid sample chamber 22, which is in fluid communication with the receptacle 14, as shown in FIGS. 4 and 5, for receiving a sample 26 of fluid 28.

Importantly, as illustrated in the figures, the handle 18 is removable from the receptacle 14 for storage, transport, and dispensing of the body fluid sample 26, for testing analysis as hereinafter described.

Following collection of body fluid 28 in the receptacle 14, a lid 30 may be screw 32 fitted to the receptacle in order that it may be safely disposed without leakage of any remaining body fluid 28.

As illustrated in the figures, following removal of the handle 18 with fluid sample 26 therein, a tip cap 36 is provided for sealing a handle tip 40.

As shown, a plunger 44 with plunger head 46 is provided for withdrawing the fluid sample 26 from the receptacle 14 with the plunger 44 and head 46 being shorter than the chamber 22 by a distance d as shown in FIGS. 1 and 2.

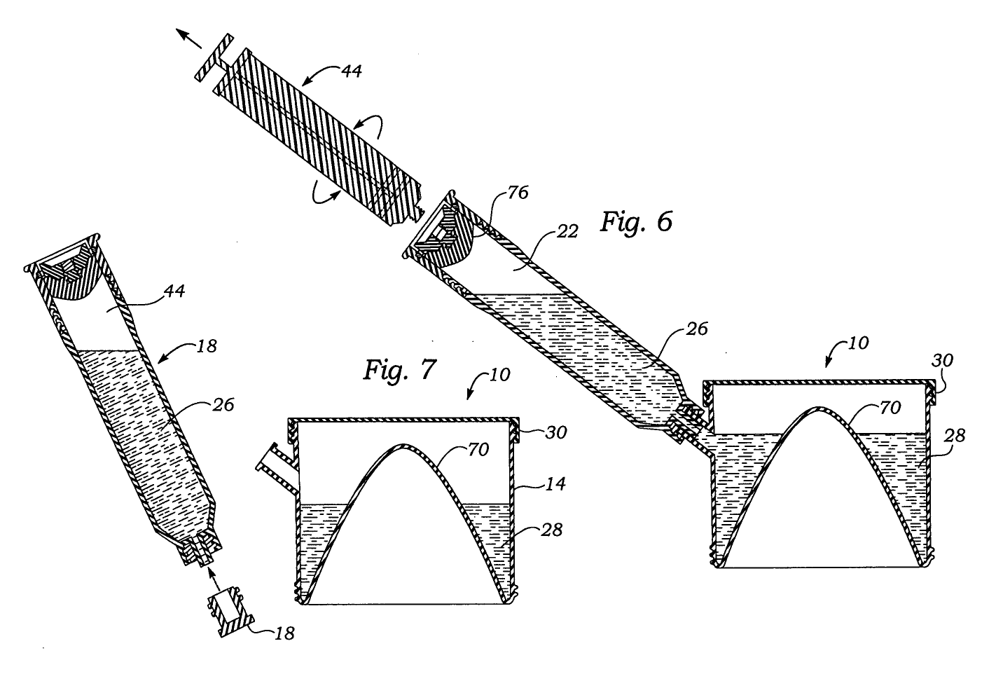

Following withdrawal of the fluid sample 26 into the handle chamber 22, the plunger 44 is removed from the plunger head 46, as illustrated in FIG. 6. Following sealing of the tip 40 with the tip cap 36 the handle 18 with fluid sample 26 therein is safely transported. A stopper ring 50, most clearly seen in FIGS. 2 and 3, provides an upward limit for withdrawal of the plunger, as well as prevent removal of the plunger head 46 from the handle chamber 22.

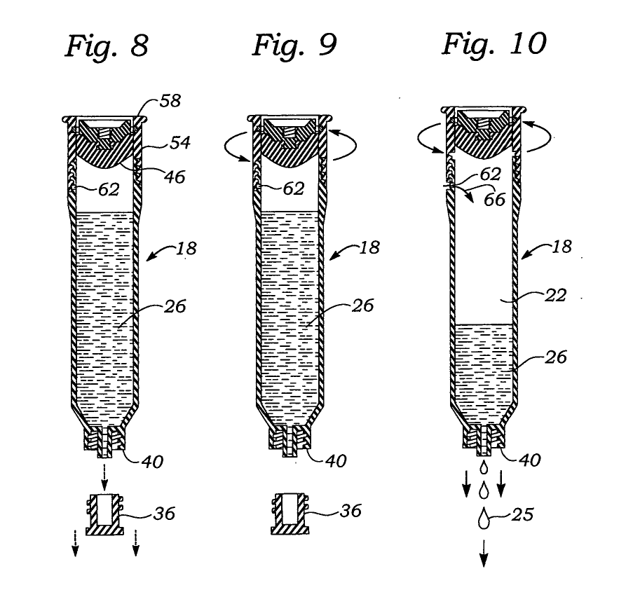

With specific reference to FIGS. 8-10, a rotatable barrel 54 is provided at an end 58 of the chamber 22 opposite the tip 40 and the chamber 22 includes an air vent aperture 62 which when exposed by upward rotation of the barrel 54 enables dispensing of the fluid sample from the chamber 22 by venting the chamber 22 illustrated by the arrow 66.

With particular reference to FIGS. 1, 4-7, and 13-15, the receptacle 14 is suitable for low output patients through the inclusion of a displacement member 70 fixed within the receptacle 14 at a position for raising the fluid level sample within the receptacle to a fitting 72 through a sidewall of the receptacle 14 which provides a fluid communication between the receptacle 14 and the handle chamber 22.

Any suitable fitting 72 for sealably engaging the tip 40 may be utilized. The fitting may be self-sealing or a separate cap, not shown, utilized to close the fitting 72 after removal of the fluid sample 26 by the handle 18.

The displacement member 70 increases the efficiency of the system 10 in that less fluid need be collected in order to provide fluid communication between the receptacle 14 and the handle 18 in order to transfer the sample 26 into the handle 18 from the fluid 28. This is preferable for low output patients. As specifically illustrated in FIG. 12, the receptacle 14 and handle 18 may be tilted, as shown, in order to manipulate fluid delivery through the fitting into the handle chamber 22.

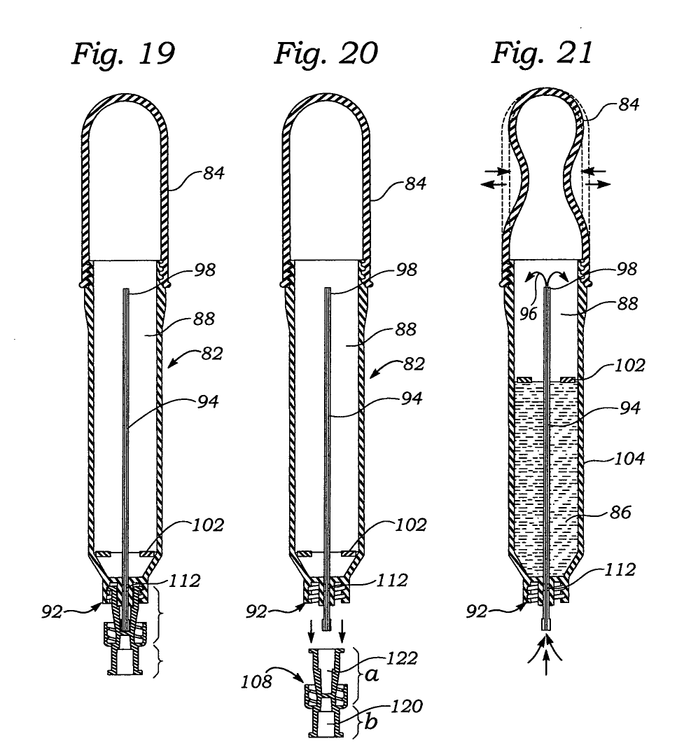

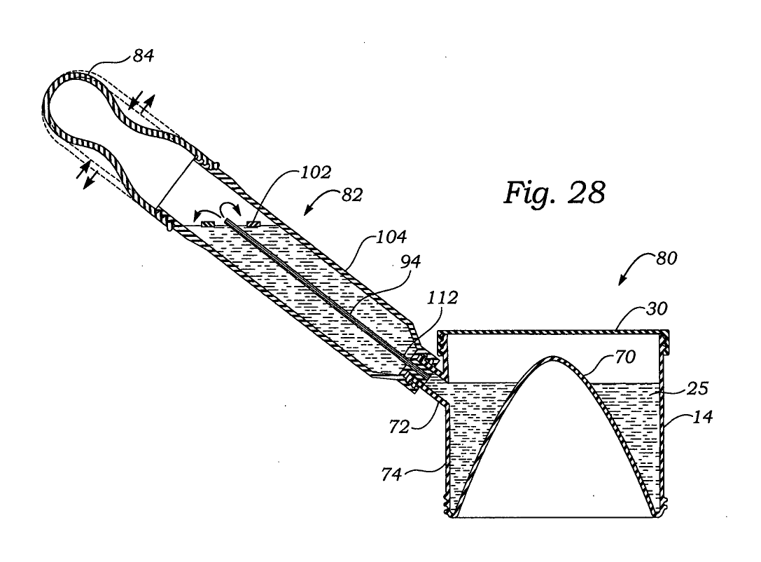

With reference now to FIGS. 19-28, there is shown another embodiment of a body fluid collecting, transporting, and dispensing system 80 in accordance with the present invention (see FIG. 28), which includes a handle 82 having a squeezable bulb 84, as indicated in FIGS. 21, 23, 25, 27, and 28 for withdrawing a fluid sample 86 from the receptacle 14 and into a fluid sample chamber 88.

A tip 92 is provided for attachment with the fitting 72 and withdrawing the fluid sample 86 through the fitting 72, as hereinbefore described and further a movable center tube 94 is provided for introducing the fluid sample into the chamber 88, as illustrated by the arrows 96 in FIG. 21 by compression and expansion of the bulb 84.

The introduction of fluid sample 86 occurs through a tube end 98, which is spaced apart from the tip 92, with the end 98 being disposed below the squeezable bulb 84.

In order to more clearly define the level of the fluid sample 86 within the chamber 88 a chemically inert float 102, of any suitable type surrounding the center tube 72, may be provided which is visibly noted within the chamber 88 through the use of a transparent, or translucent chamber sidewall 104.

In this embodiment 82, there is provided a cap 108 which not only seals the tip 92 but also functions to move the center tube 94 from a first position in which a sidewall opening 112 is sealed, see FIG. 21, to a second position in which the sidewall opening 112 is uncovered, thus enabling discharge of the fluid sample completely through the tip 92 as indicated by arrows 114, 116.

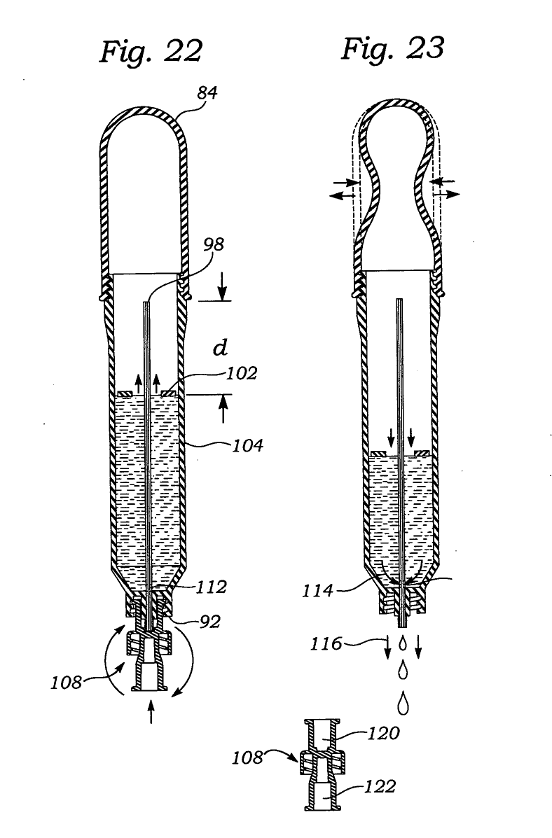

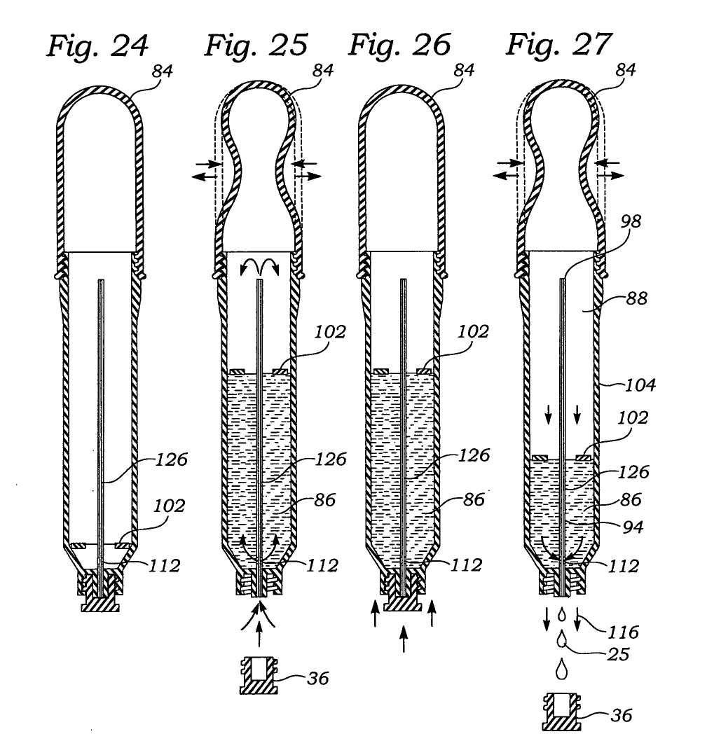

Movement of the center tube 94 by the tip 108 is accomplished through the use of two opposing cavities of different depths, a, b with the first cavity 108 enabling sealing of the tip 92 without engagement with the center tube 92 and a second cavity 120 enabling sealing of the tip 92 with engagement and movement of the center tube 94 to a second position, to expose the sidewall opening 112 as illustrated in FIG. 22. Alternatively, as shown in FIGS. 24-27, a fixed tube 126 may be utilized along with the sidewall opening 112.

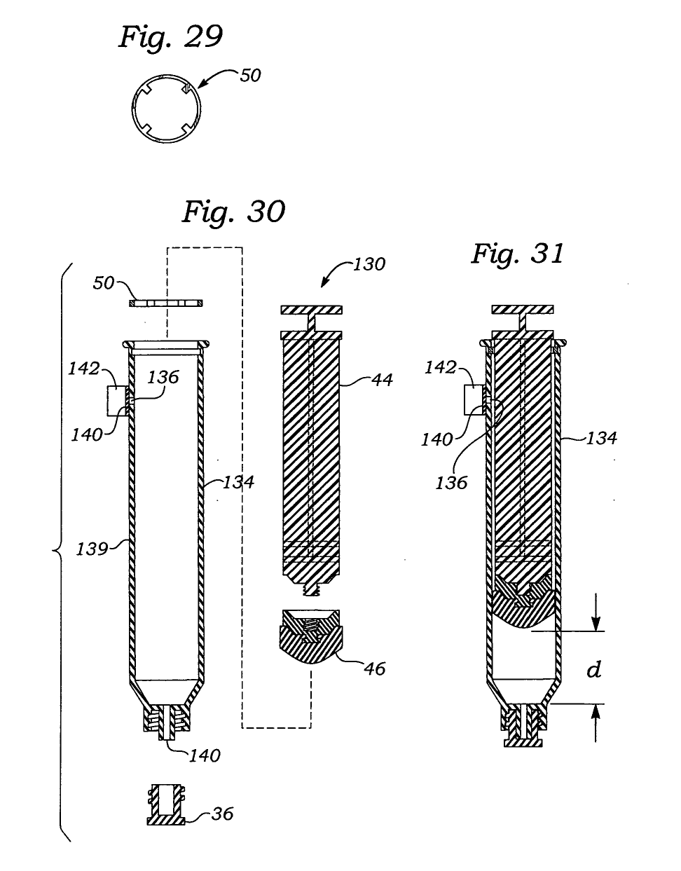

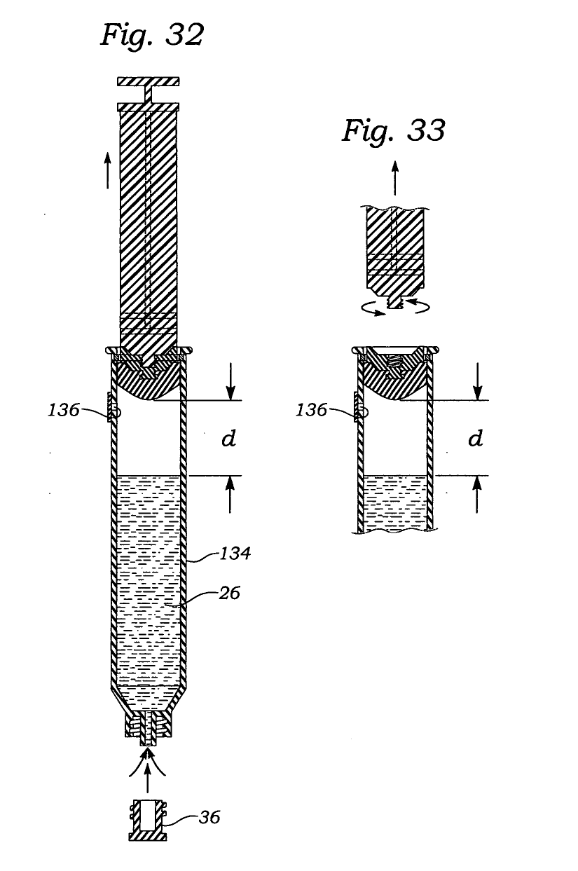

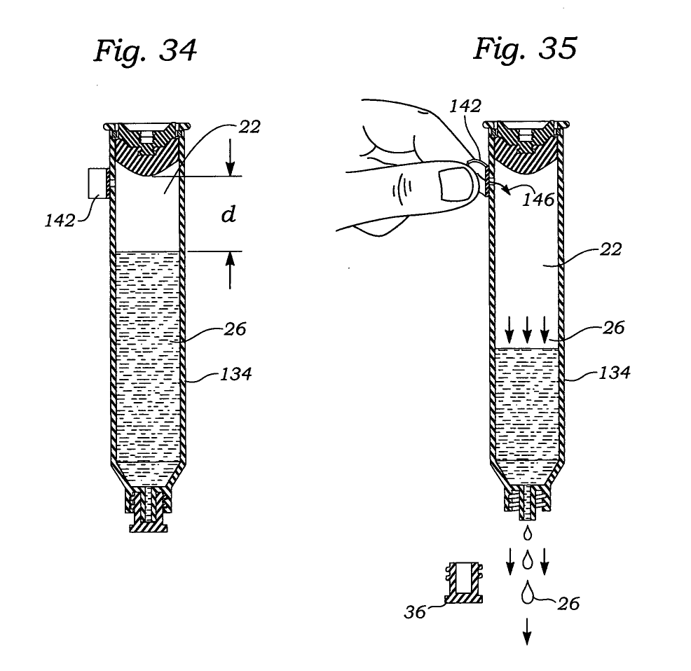

A further handle embodiment 130 is illustrated in FIGS. 29-35 in which a chamber wall 134 includes a port sealable by a separable adhesive tape 140 facilitated through the use of a tab 142.

After collection of the fluid sample 26, as hereinabove described, the tape 140 may be separable from the wall 134 to expose the port 136 through the use of the tab 142, as illustrated in FIG. 35 in order to vent the chamber, as indicated by the arrow 146 and dispensement of the fluid sample 26 after removal of the tip cap 36, common reference numbers indicating identical or substantially similar components as hereinabove described.

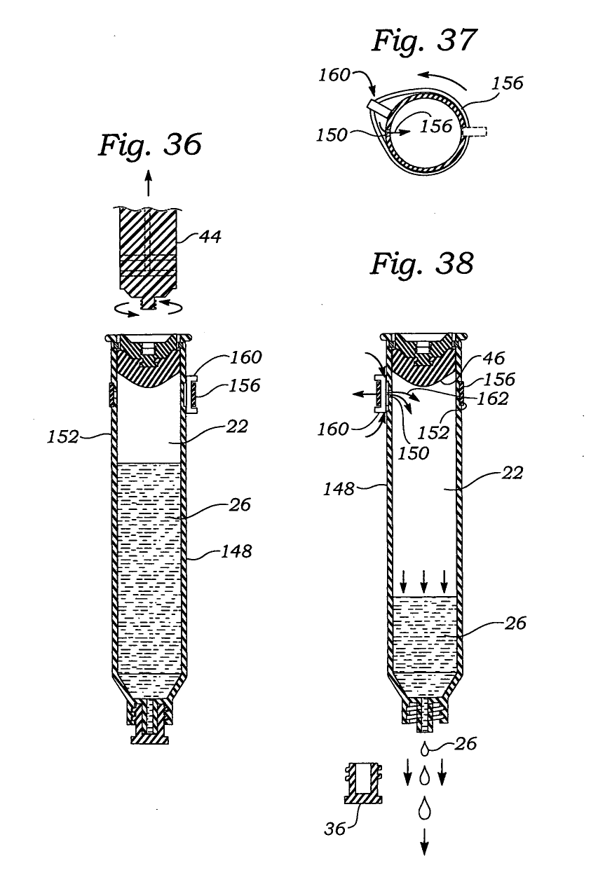

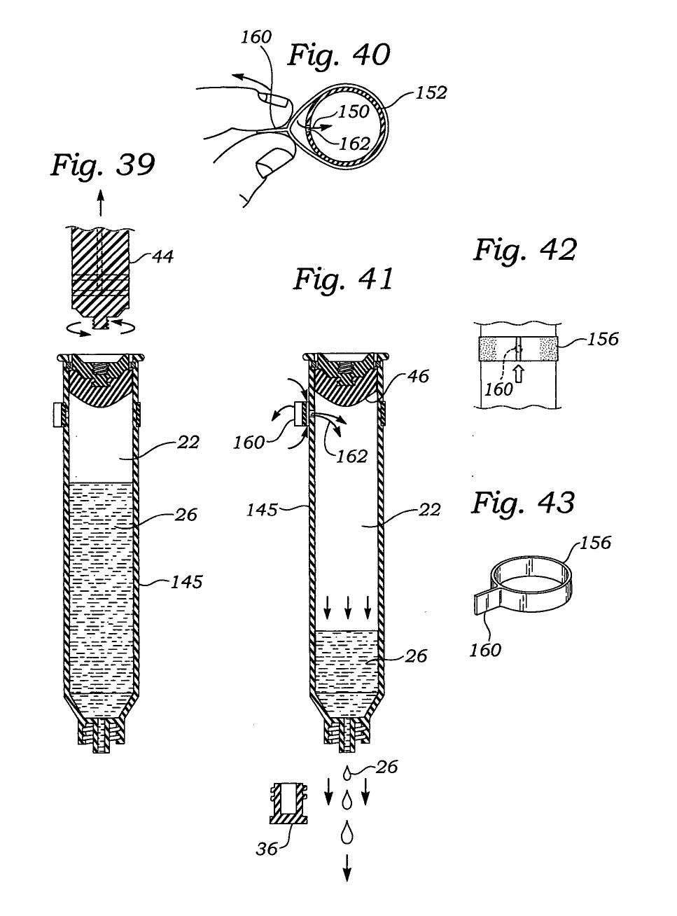

FIGS. 36-43 show yet another embodiment of a chamber wall 148 includes a sidewall opening 150 along with a circumferential recess 152 in the chamber wall 148 for accommodating an elastic member 156 for sealing the opening 150 as illustrated more specifically in FIGS. 37-43, a grip mechanism 160 is provided for stretching the elastic member 156 in order to open the opening 150 to dispense the fluid 26 therein by entrance of air indicated by the arrows 162.

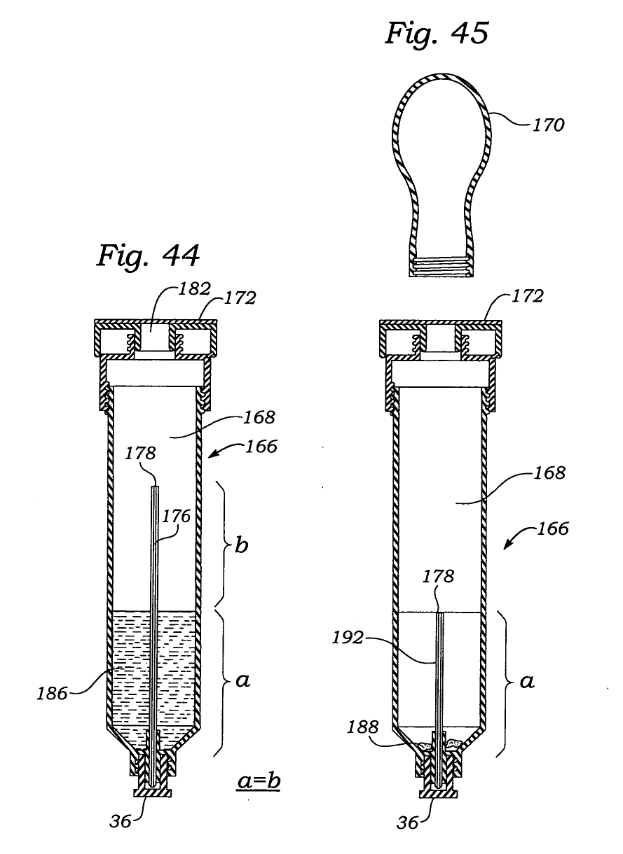

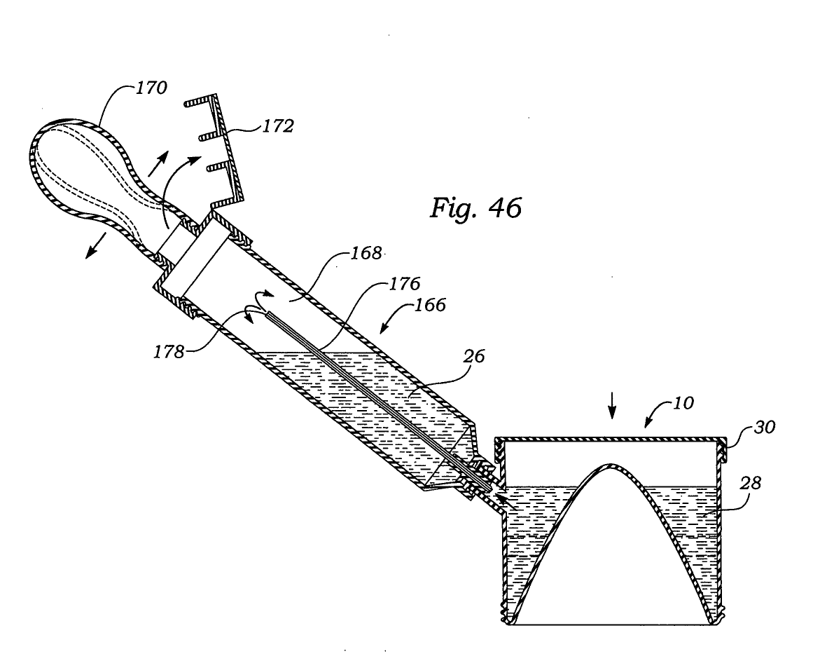

Still another embodiment of a handle 166 is illustrated in FIGS. 44-45, which includes a removable bulb 170 and a flip top lid 172, see particularly FIG. 46. A center tube 176 without sidewall opening enables collection of the sample 26 without release thereof when the level is below a top 178 of the tube 176. After unscrewing of the bulb 170, the flip cap 172 seals a top 182 of the handle 166. This rapid sealing is to prevent inhalation of aerosol pathogens such as chlamydia trichomatis or the like, evolved from any hazardous sample, by any healthcare workers.

In addition, as indicated in FIG. 44, the handle 166 may be preloaded with a liquid active reagent 186 which provides for a one to one blend of sample and liquid active agent when the handle is filled to the top 178 of the tube 176, as indicated by the letters a and b in FIG. 44.

Alternatively, a solid active reagent 188 may be predisposed in the chamber 168 for dissolution by the fluid sample 186. In this instance, a shorter tube 192 may be utilized in the procedure shown in FIG. 46 is as hereinabove described in connection with earlier disclosed embodiments, however the resulting concentrated of reagent 188 in the sample 186 is the same.

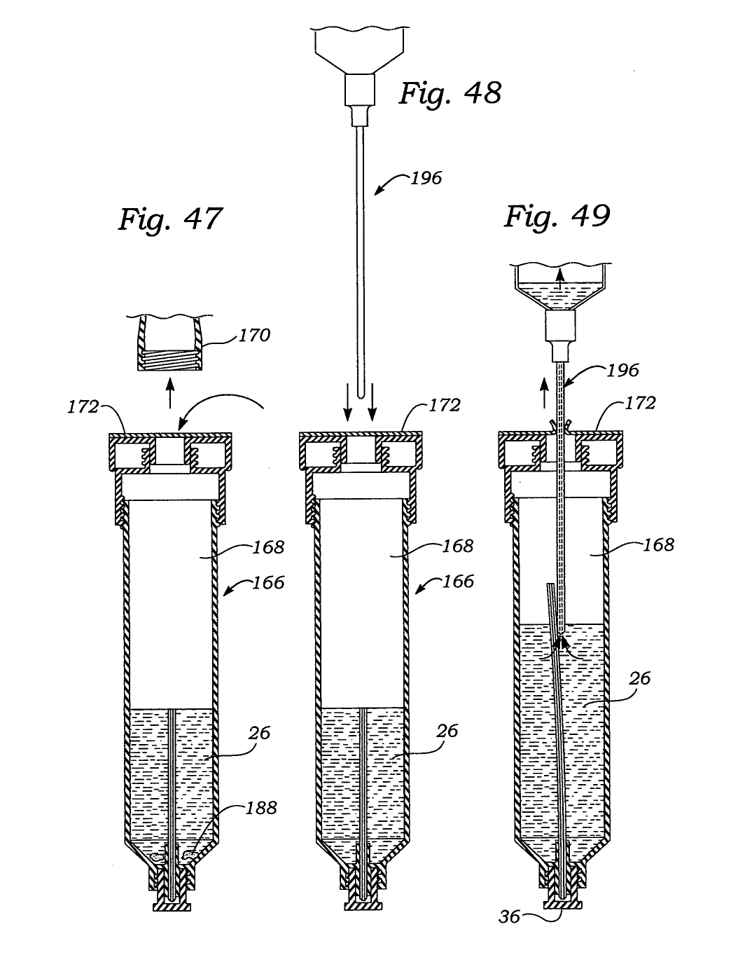

As illustrated in FIGS. 47-49, the flip top 172 may be puncturable, thus enabling removal of some of the fluid sample 26 by a syringe or needle 196 of a specialized analytical machine (not shown).

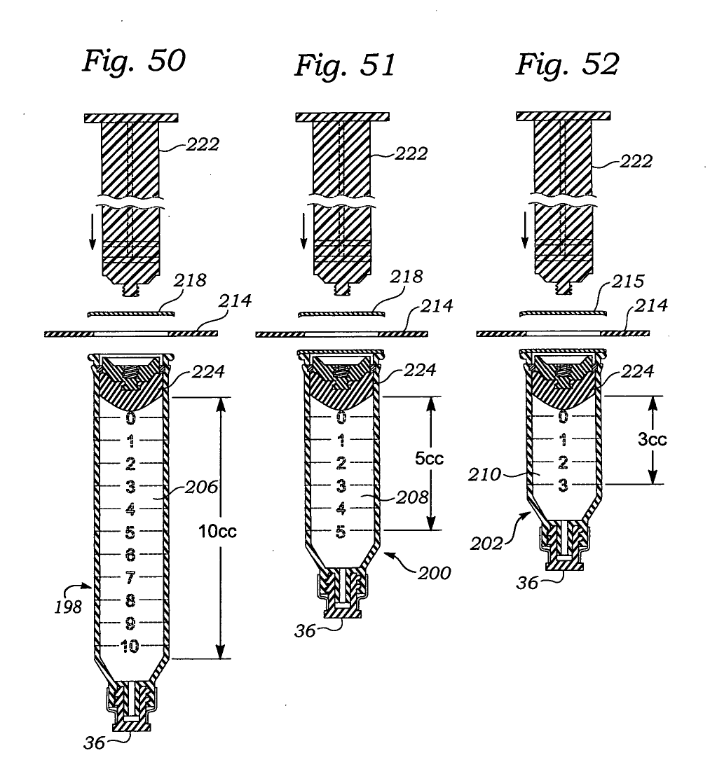

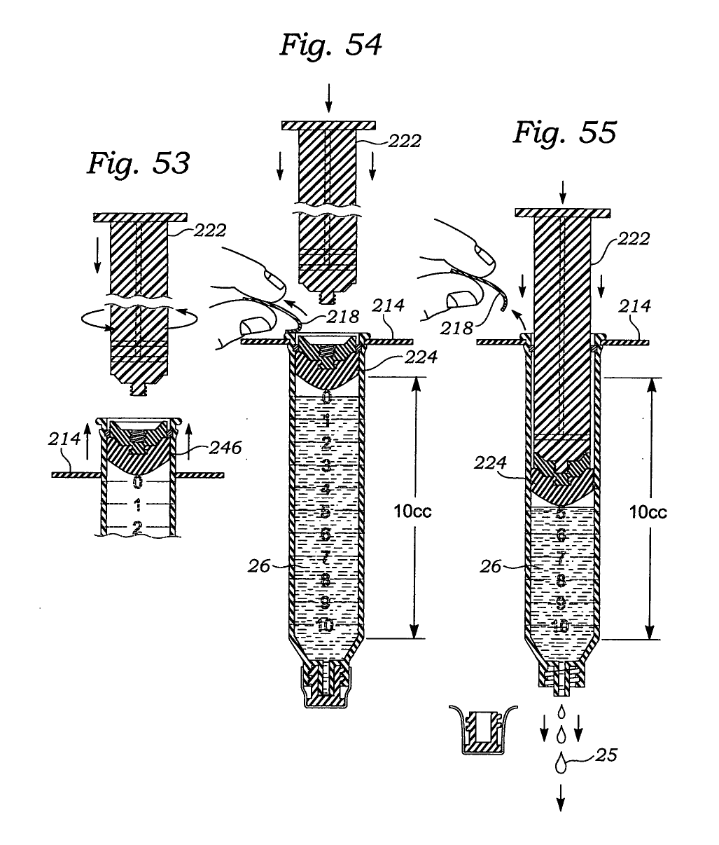

As shown in FIGS. 50-52, a plurality of handles 198, 200, 202 may be provided with different sized chambers 206, 208, 210 with the volume indicia printed thereon for convenience. This facilitates several sample sizes to be used in storage of active agents, medications, and the like in prefilled form for easy and handy dispensing.

A removable wing 214 may be provided to enable denser packing of the handles 198, 200, 202 with specimens therein for shipment. A tamper evident seal 218 may be provided and removed before a reusable plunger 222 is engaged with a plunger head 224 for dispensing of a fluid sample as illustrated in FIG. 55.

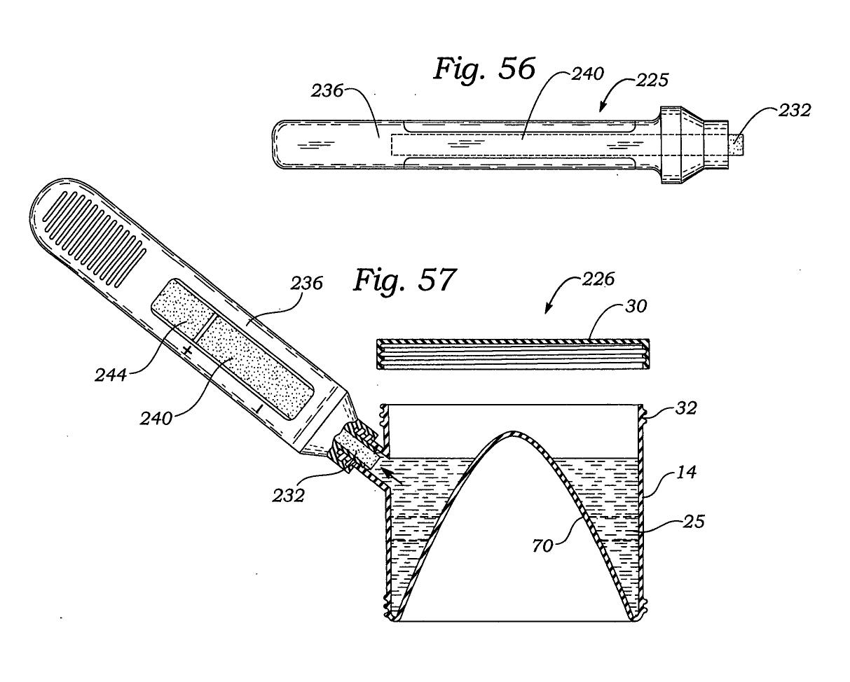

With reference to FIGS. 56-57, there is shown a system 226 in which a handle 228 is provided for supporting the receptacle 14 in a fluid collection position in which the handle includes a wick 232 for attracting fluid into a handle chamber 236 which further includes a diagnostic reagent strip 240 for indicating the presence of at least one specific component of the fluid sample through a chamber window 244. The reagent strip 240 may be of any suitable type well known in the art for conducting invitro diagnostic assays.

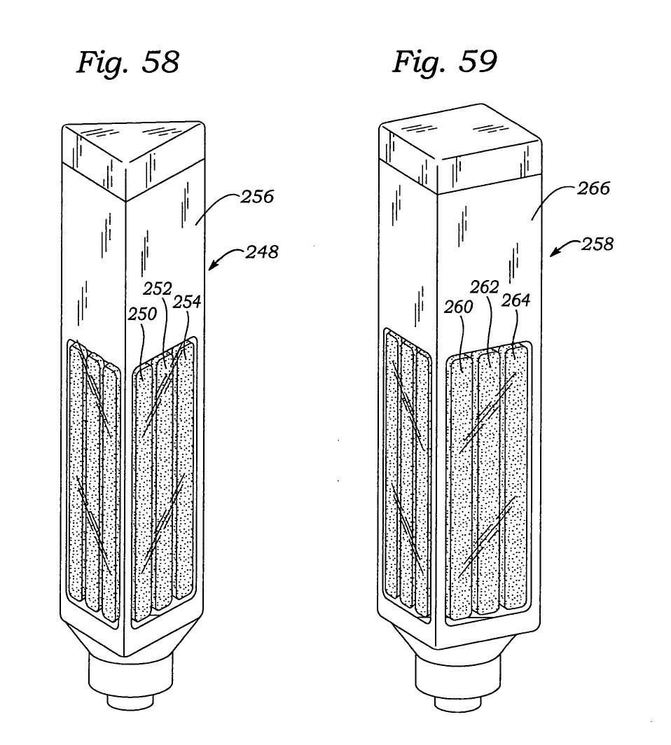

FIG. 58 illustrates a handle 248 having a triangular cross section with a plurality of diagnostic reagent strips 250, 252, 254 disposed along faces 256 of the handle 248 for indicating the presence of a plurality of specific components of the fluid sample.

With reference to FIG. 59, handle 258 have a rectangular cross section with a plurality of reagent strips 260, 262, 264 disposed along each rectangular face 266 for indicating the presence of a plurality (in this case 12) specific panels of the fluid sample can be simultaneously assayed.

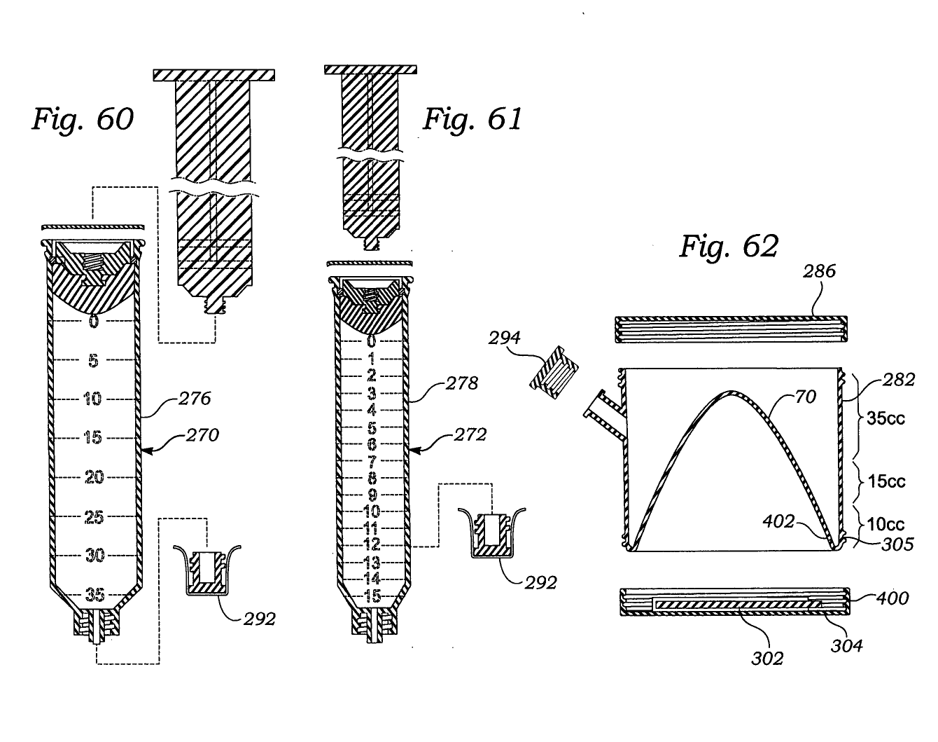

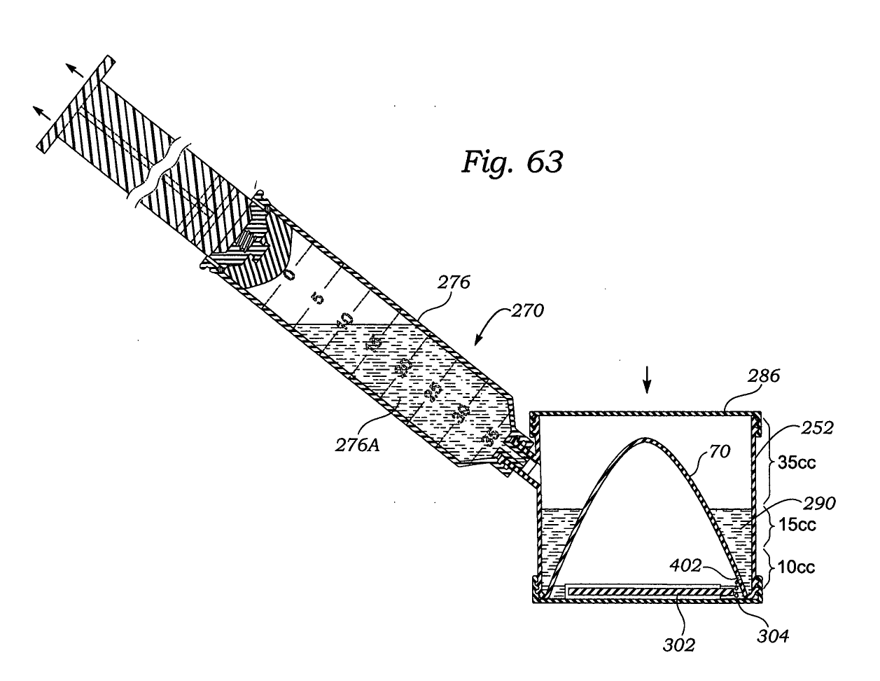

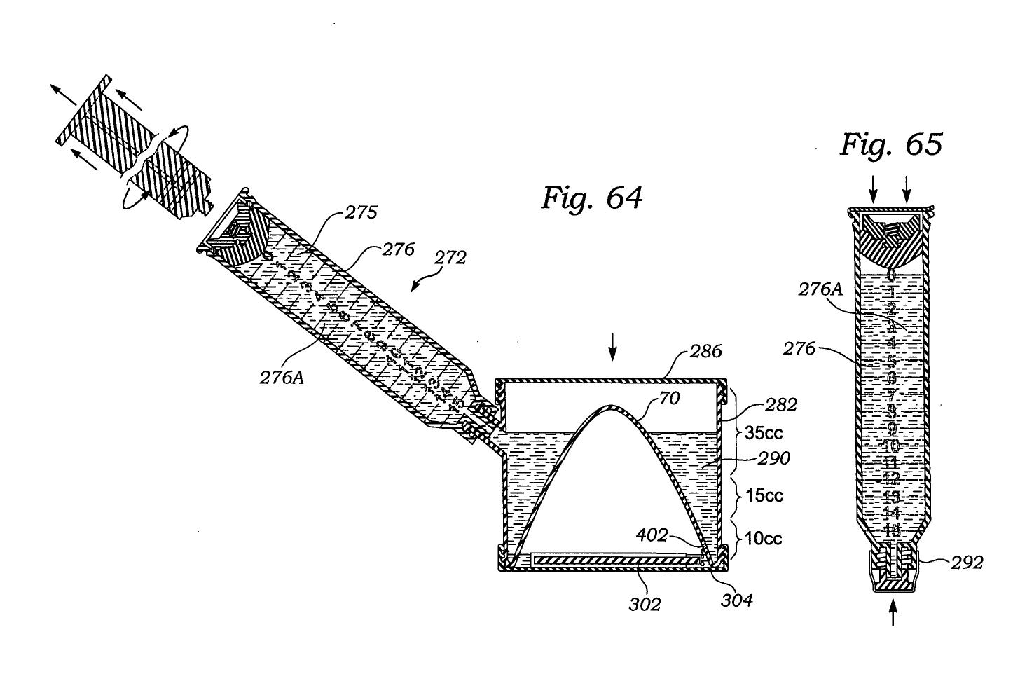

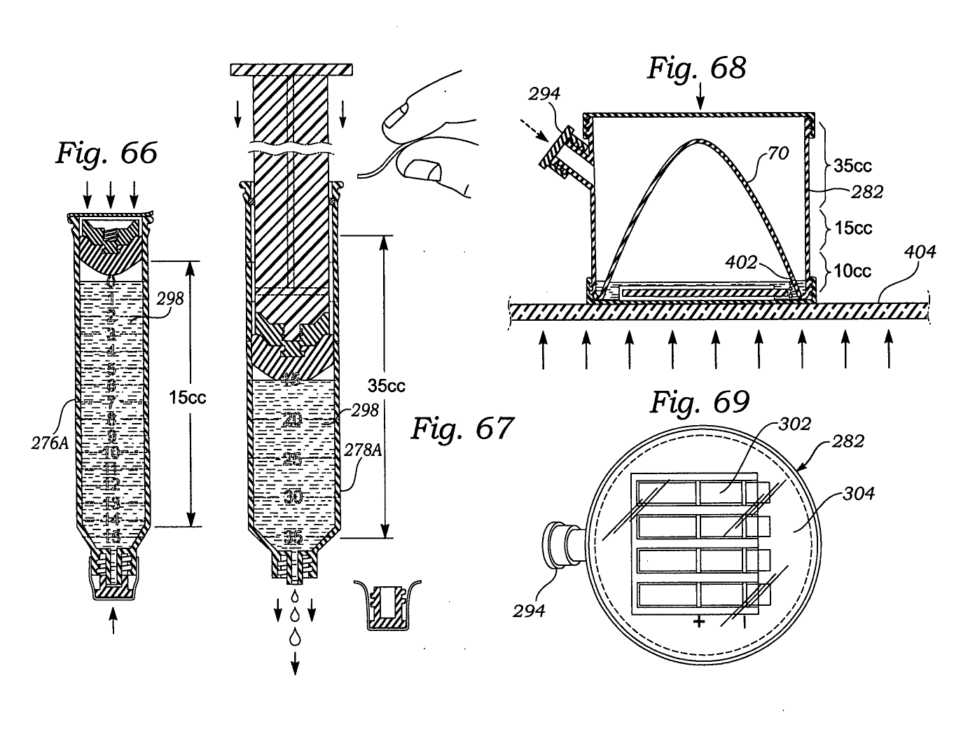

FIGS. 60-69 show yet further embodiments 270, 272 in accordance with the present invention using various calibrated handles 276, 278 for collection of samples 276A, 278A the operation of which is identical to earlier embodiments hereinabove discussed. Tamper proof caps 292 may be provided.

The embodiments 270, 272 include a receptacle 282 with lid 286 and displacement member 70 for a collection of body fluid 290 as indicated.

As hereinabove noted, a cap 294 may be provided for a sealing of the receptacle 282 after withdrawal of the fluid sample 290 from the receptacle 282.

In these embodiments 270, 272 the receptacle 282 includes at least one diagnostic reagent strip 302 disposed at a bottom lid 304 of the receptacle 282, the bottom lid 304, preferably transparent and being removable by way of threads 400, enables visibility of the strips 302 through the bottom lid 304 which, in addition, can be recorded by placement on a copy machine plate 404 as indicated in FIG. 68. The diagnostic reagent strip 302 is flooded or wetted by passage of flow through hole 402.

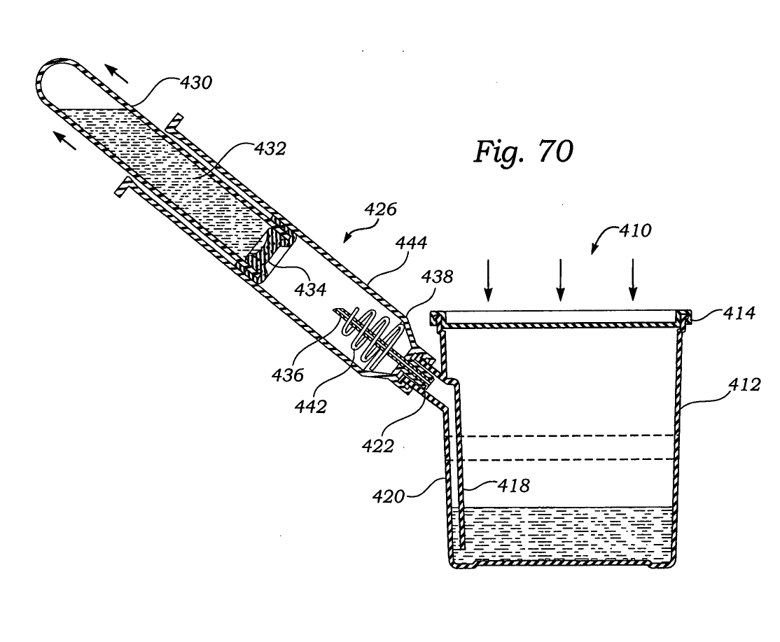

Still another system embodiment 410 is illustrated in FIG. 70. This embodiment 410 includes a receptacle 412 with lid 414 along with an integral tube 418 which in combination with the sidewall 420 forms a fitting 422 to which a sample withdrawing handle 426 is attached as shown in FIG. 70.

In this embodiment 410, a tube holding housing 444 includes a removable vacuum tube 430 for receiving a fluid sample 432, which is collected from the receptacle 412 through the fitting 422 by puncture of a bottom seal 434 by a needle 436 integrated in a bottom 438 of the housing 444. A tapered compression spring 442 is provided for facilitating removal of the tube 430 from a handle housing 444.

The bottom seal 434 is self-sealing, thus removal of the vacuum chamber provides for a sterile transmission thereof to a testing laboratory.

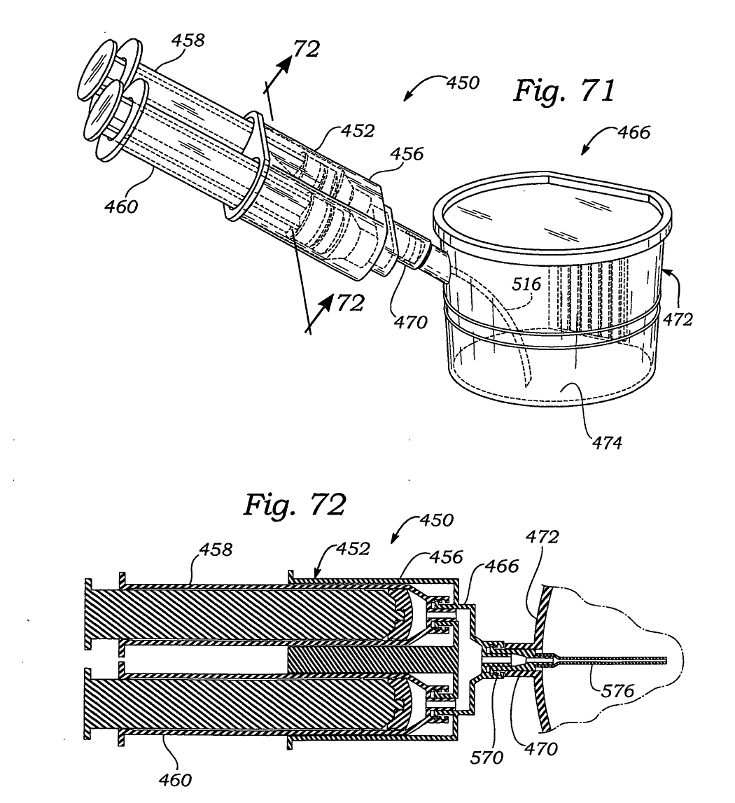

FIG. 71 is a perspective drawing of a fluid (biological specimen) collection and transporting system 450, which may be used and functions similar to other embodiments hereinabove described except that FIG. 71 shows a dual syringe assembly 452 comprising a housing adapter 456 having installed therein, in a parallel arrangement, two syringe assemblies 458, 460.

The housing adapter 456 is detachably connected to a container assembly 466, at a sidewall fitting 470 to a receptacle 472.

Thus, the system 450 provides two, rather than a single, tamper proof urine sample simultaneously. One of the samples may be forwarded for on-site abusive drug analysis and the other sample may be retained, for example, by the urine supplying individual, for confirmation purposes, if needed.

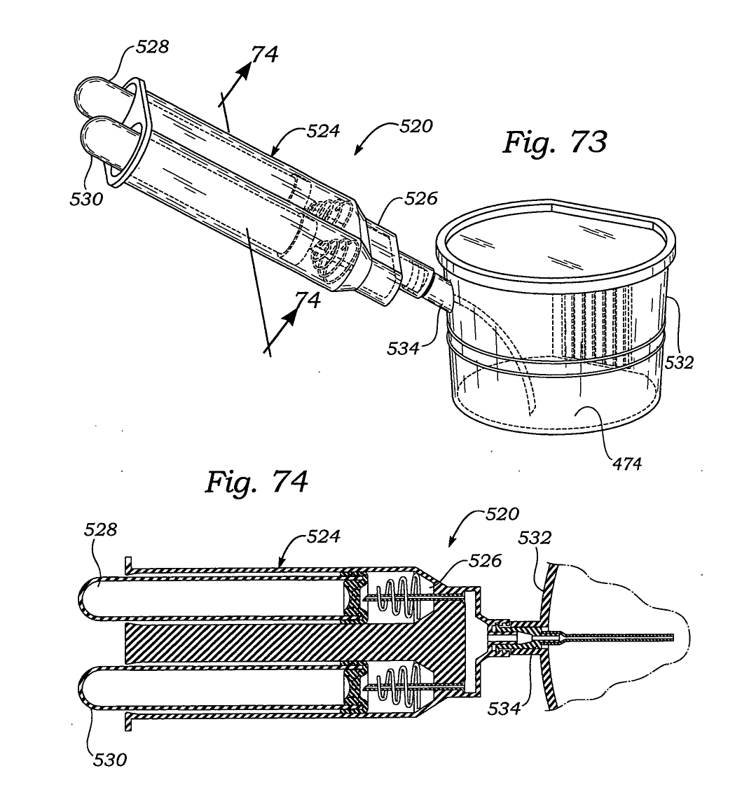

FIG. 72 is a longitudinal cross-sectional drawing taken along line 72-72 of FIG. 73 showing construction of housing adapter 452 and the manner in which the two syringe assemblies 458, 460 are installed therein.

The housing adapter 452 includes a female leur lock region 470 for connecting to container male leur fitting 470 for detachable connection of dual syringe assembly 452 to receptacle 472.

A single tube, a needle, or conduit, 516 enable a fluid sample into both of the syringe 458, 460. The conduit 516 extends to a bottom 474 of the receptacle 472 in order to completely remove fluid received from patients with low output.

The filled syringe assemblies 458, 460 are then withdrawn from the housing adapter 456 and individually processed in the manner as hereinabove described, and on-site abusive drug testing may also be performed as desired or required. The housing adapter 456 may be constructed in several pieces which are subsequently assembled.

FIG. 73 is a perspective drawing of another dual body fluid (biological specimen) collection and transporting system 520 which corresponds generally to FIG. 70, and which is intended to be used and function in accordance with above-described FIG. 70 except FIG. 73 shows a dual urine sample collection assembly 524 comprising a housing adapter 526 installed therein, in a parallel arrangement, two vacuum-type sample collecting tubes 528, 530 are as hereinabove described.

As shown the housing adapter 526 is detachably connected to a container assembly 532, at a sidewall fitting 534 (in the manner depicted in FIG. 70 for the single vacuum tube syringe body).

Thus, system 520 provides two, rather than a single, tamper proof urine sample simultaneously. As hereinabove noted, one of the sample may be forwarded for drug analysis and the other may be retained, for example, by the urine supplying individual, for confirmation purposes, if needed.

FIG. 74 is a longitudinal cross-sectional drawing taken along line 74-74 of FIG. 73.

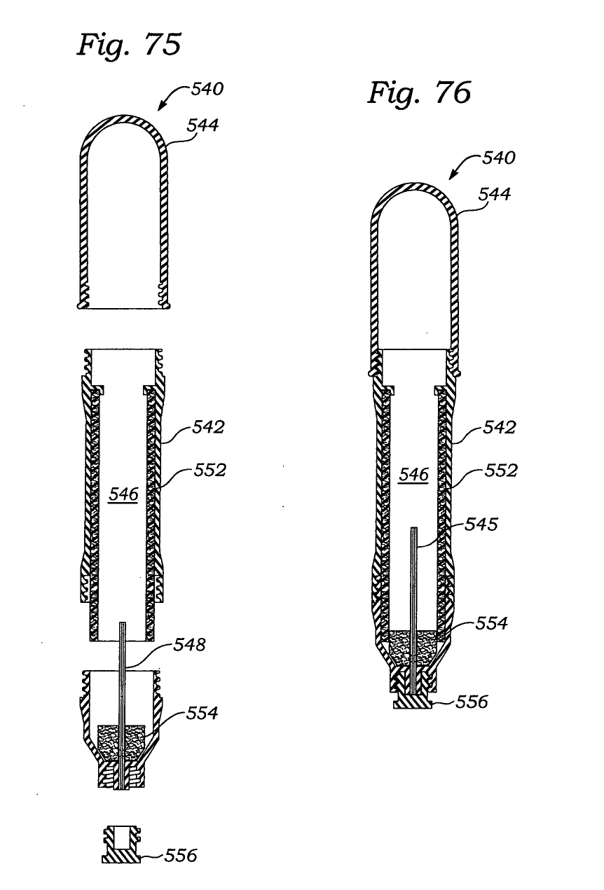

With reference now to FIGS. 75 and 76, there is shown an alternative embodiment 540 similar to the embodiment shown in FIGS. 58-59, however including a sidewall 542 for receiving an attachable and squeezable bulb 544 for transferring a biological sample into the chamber 546 via a tube 548 for contact with testing with one to four diagnostic strip panels 552 with an absorbent 554 provided to prevent over-flooding the chamber 546.

As shown in FIG. 75, the bulb 544 is removable and various bulb sizes may be provided (not shown) for adjusting the standard specimen intake desired. A cap 556 may also be provided to prevent egress of fluid sample from the handle 540 during handling thereof.

The panels may be conventional test panels for testing urine, glucose, protein, pregnancy, ovulation, drugs of abuse, or also IVD testing when saliva and blood are used as the fluid sample. Thus, the present invention enables needle free testing of hazardous blood samples.

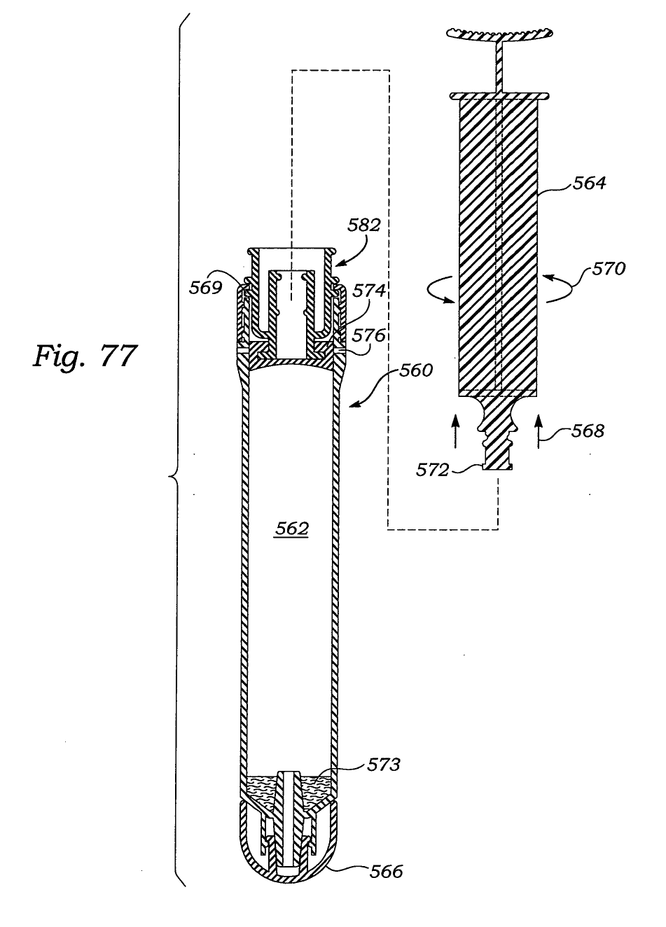

With reference to FIG. 77, there is shown an alternative handle embodiment 560 for providing an on-site evacuated chamber 562 for operation similar to the commercial prevacuation tube embodiment 426 shown in FIG. 70.

In the embodiment 560, when a chamber 562 is evacuated through the use of a piston 564, which evacuates the chamber 562 with a cap 566 in place when the piston 564 is withdrawn in direction of the arrows 568. Upward movement of the piston 564 is limited by a lock 569. This leaves an evacuated chamber 560 with a piston head 574 disposed over vent holes 576. Thereafter, the piston 564 is removed by rotation thereof, as indicated by the arrows 570 with release being enabled by screw threads 572. A clot activating gel 573 may be provided to enhance serum separation.

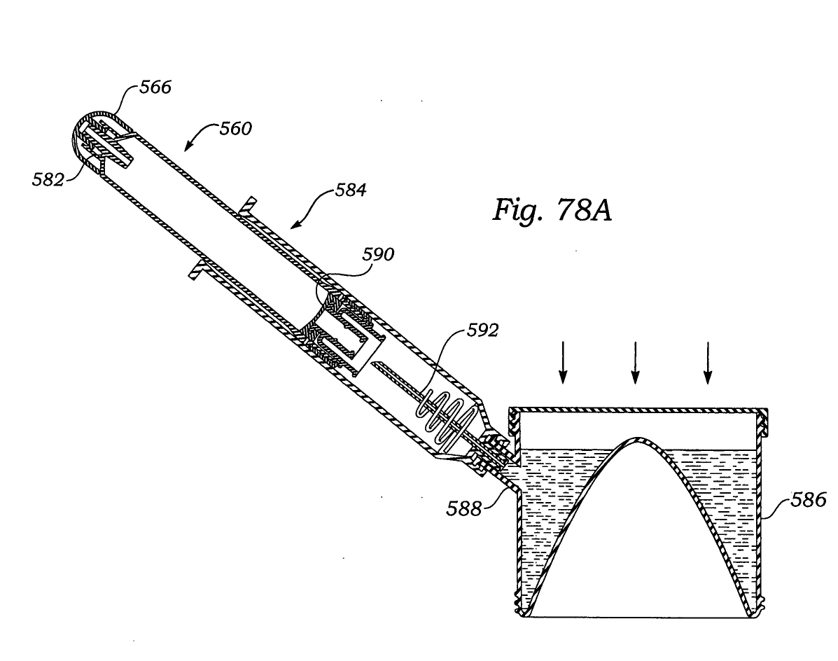

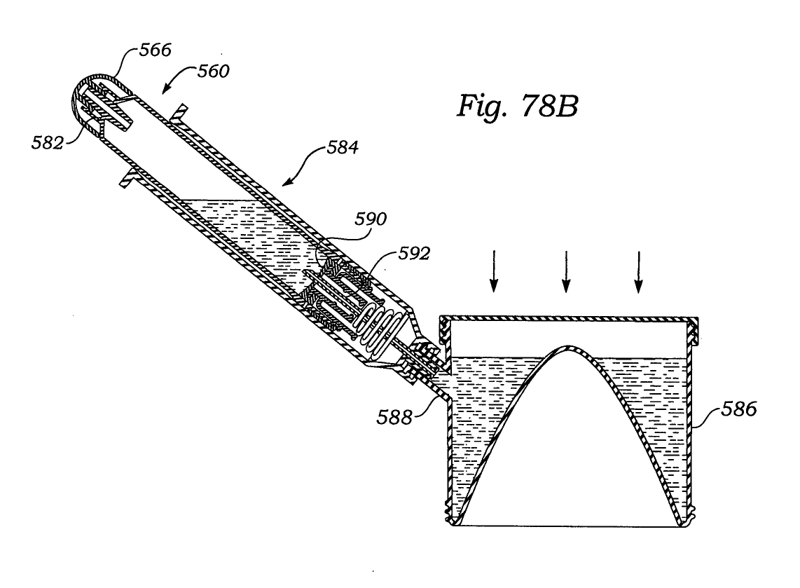

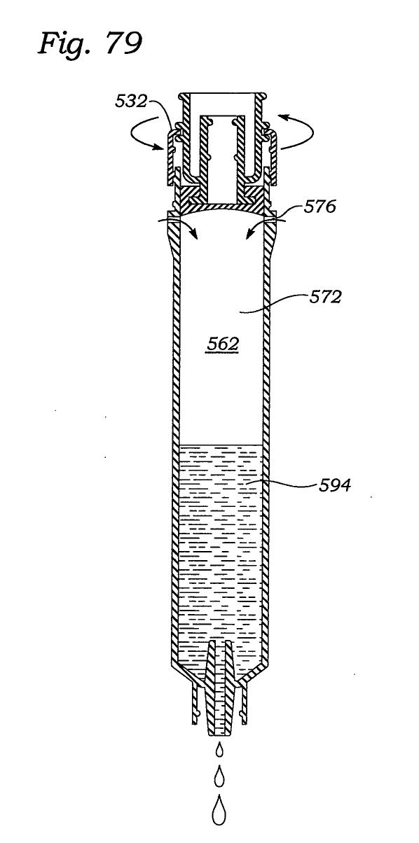

With reference to FIG. 78A, a cap 580 is then disposed over a top end 582 of the handle 560. Insertion of the handle 560 into a housing handle 584 interconnected to a receptacle 586 via a fitting 588 (See FIG. 78B) enables puncture of a diagram 590 by a needle 592 thereby causing fluid sample to enter into the chamber 560 via the vacuum established therein, as hereinabove described in the connection with the embodiment 426 shown in FIG. 70.

Following transport, the cap 566 is removed and the top 582 rotated, as illustrated in FIG. 79, to expose the vent holes 576 thus enabling dispensing of the fluid sample 594 from the chamber 562 as illustrated.

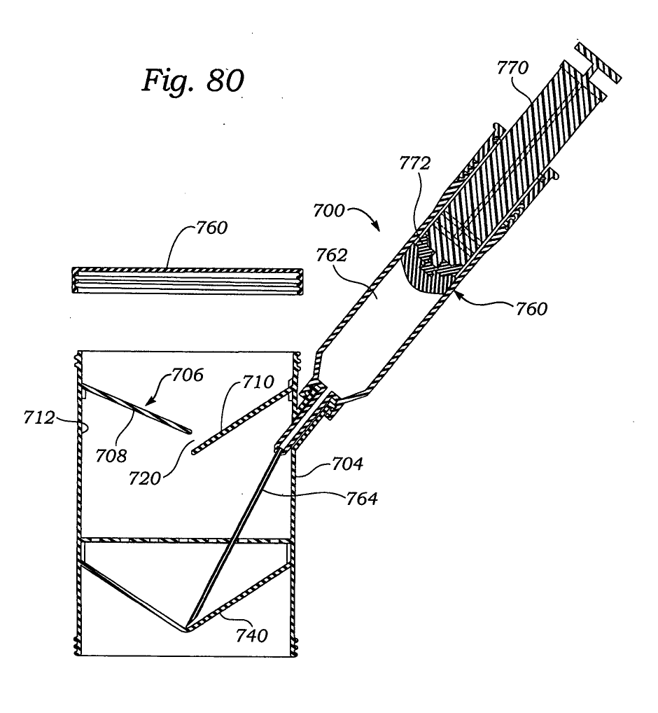

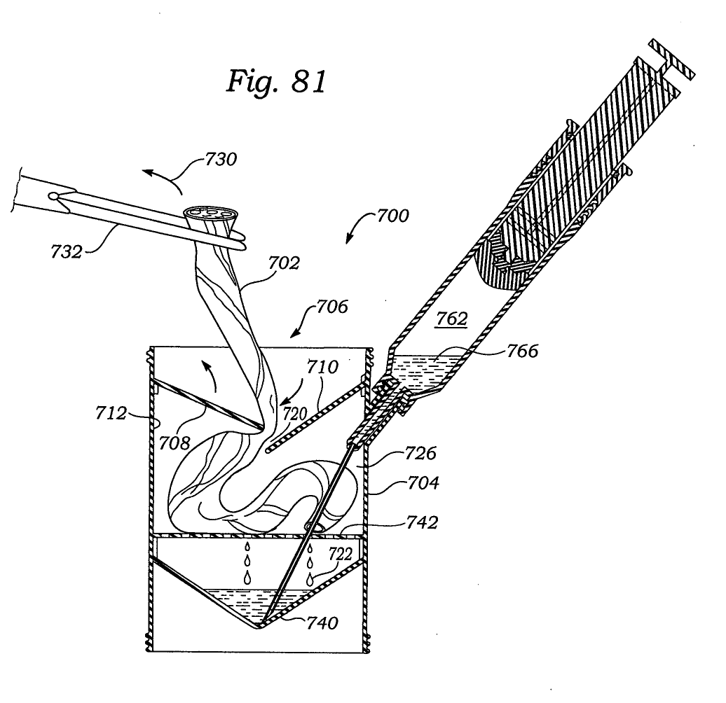

With reference to FIGS. 80 and 81, there is shown still another embodiment 700 in accordance with the present invention specifically for system for collecting, storage, transporting, and dispensing of blood samples, for example, as may be collected from an umbilical cord 702, as illustrated in FIG. 81.

The body fluid collecting, storing, transporting, and dispensing system 700 generally includes a body fluid collection chamber 704 which includes an closed system 706 which preferably includes spaced apart flanges 708, 710 fixed to an inside wall 712 of the receptacle 704 and including a gap 720 therebetween which is sized for squeezing, or expressing, blood 722 from the umbilical cord 702 as illustrated in FIG. 81. The process includes insertion of the umbilical cord 702 past the flanges 708, 710 and into an upper chamber 726 of the receptacle 704 and thereafter withdrawing the umbilical cord 702 against the edges of the flanges as indicated by the arrow 730 by conventional means, such as, for example, surgical clamps 732.

As illustrated, the receptacle 704 includes a V-shape cross section bottom 740 and a separator 742, such as a mesh plate or the like, suspends the umbilical cord 702 from the receptacle bottom 740 thus enabling free collection of the precious umbilical cord blood sample in the V-shaped bottom 740.

With reference to FIG. 80 a cap 760 may be provided for sealing the receptacle 704.

The handle 760 is provided for supporting the receptacle 704 in a fluid collection position as illustrated in FIG. 81 and further includes fluid sample chamber 762 in fluid communication with the receptacle through a tube or needle 764 in order to remove the blood sample 766 into the chamber 762.

The sample 766 may be withdrawn into the chamber 762 by a conventional piston 770 along with piston headset 772, as hereinabove described in connection with the earlier presented embodiments, or any of the hereinabove described alternative embodiments.

Following removal of the sample 766, the handle 760 is sealed, transported, and fluid dispensed thereof in accordance with any one of the embodiments hereinbefore discussed. It should be appreciated that any of the hereinbefore described handle embodiments may be utilized with the receptacle 704.

Although there has been hereinabove described a specific biological specimen collection, storage, and transportation system in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A body fluid collecting, transporting, and dispensing system comprising:
a body fluid collecting receptacle; and
a handle supporting the receptacle in a fluid collection position, said handle including a fluid sample chamber in fluid communication with the receptacle to receive a sample of the body fluid, said handle being removable from the receptacle for transport, storage, and dispensing of the body fluid sample.

2. The system according to claim 1 wherein said handle comprises a plurality of fluid sample chambers each receiving a separate sample of the body fluid.

3. The system according to claim 1 wherein said handle comprises a sample withdrawing plunger with a head disposed in the chamber, and a tip for withdrawing the fluid sample through a fitting in the receptacle.

4. The system according to claim 3 wherein said plunger is removable from the head and handle and the system further comprises a tip cap to facilitate safe transport of the handle with the fluid sample.

5. The system according to claim 4 wherein the fluid sample chamber includes a rotatable stopper at an end opposite of said tip and the fluid sample chamber includes an air vent aperture, the aperture being disposed at a position exposable by rotation of the stopper in order to enable dispensing of the fluid sample through said tip with the cap removed.

6. The system according to claim 1 wherein the receptacle includes a displacement member fixed within the receptacle at a position raising a fluid sample level, within the receptacle, to the fitting.

7. The system according to claim 1 wherein said fluid communication includes a fitting through a sidewall of the receptacle and spaced apart from a bottom of the receptacle.

8. The system according to claim 7 wherein the receptacle includes a displacement member fixed within the receptacle at a position raising a fluid sample level, within the receptacle, to the fitting.

9. The system according to claim 1 wherein said handle further comprises a squeezable bulb disposed at an end of the chamber to withdraw the fluid sample into the chamber.

10. The system according to claim 4 further comprising a sealable/unsealable sidewall opening in the chamber at a spaced apart distance from said tip, unsealing of the port enabling dispensing of sample fluid through the tip.

11. The system according to claim 10 further includes separable tape member for sealing the sidewall opening.

12. The system according to claim 10 further including stretchable elastic member for sealing the sidewall opening and a mechanism for stretching the elastic member to expose the sidewall opening.

13. The system according to claim 9 wherein said fluid sample chamber includes a tip for withdrawing a fluid sample through a fitting in the receptacle and a moveable center tube for introducing a fluid sample into the chamber through an end disposed at a spaced apart distance from said tip, the end being disposed below the squeezable bulb.

14. The system according to claim 13 further includes a float disposed in the chamber for indicating a level of fluid sample in the chamber.

15. The system according to claim 14 wherein said center tube is slidably received in said tip for longitudinal movement within the chamber and the center tube includes an sidewall opening therein sealed by said tip, with the center tube in a first position, and uncovered, with the center tube in a second position, to enable discharge of the fluid sample through the tip.

16. The system according to claim 15 further comprises a cap for sealing said tip and for moving said center tube from the first position to the second position.

17. The system according to claim 16 wherein said cap includes two opposing cavities of different depths, a first cavity enabling sealing of the tip without engagement with the center tube and a second cavity enabling sealing of the tip with engagement and movement of the center tube to the second position.

18. The system according to claim 9 wherein the bulb is removable from the chamber and a closable lid is provided to cover a top of the chamber

19. The system according to claim 18 wherein the receptacle includes a displacement member fixed within the receptacle at a position raising a fluid sample level, within the receptacle, to the fitting.

20. The system according to claim 18 wherein said lid includes a puncturable portion for enabling removal fluid sample by a syringe.

21. The system according to claim 1 further comprises a solid active reagent disposed in said chamber for dissolution by the fluid sample.

22. The system according to claim 21 further comprises a center tube for controlling a measured amount of sample.

23. The system according to claim 1 further comprises a liquid active reagent disposed in said chamber for mixing with the fluid sample.

24. The system according to claim 23 further comprises a center tube for controlling a measured amount of sample.

25. The system according to claim 1 wherein said fluid sample chamber initially includes a vacuum for drawing the sample from the receptacle.

26. The system according to claim 25 wherein the handle includes a vacuum tube holder.

27. The system according to claim 25 further comprises a plunger head disposed in the chamber, a removable top chamber seal and an plunger attachable to the head for dispensing of fluid sample from the chamber through a tip.

28. The system according to claim 1 wherein the handle chamber includes a wick for attracting the fluid sample into the chamber.

29. The system according to claim 28 further comprising at least one reagent strip visible through a chamber window for indicating the presence of at least one specific component of the fluid sample.

30. The system according to claim 29 wherein said chamber is rectangular in cross section and a plurality of reagent strips are disposed along each rectangular face for indicating the presence of a plurality of specific components of the fluid sample.

31. The system according to claim 29 wherein said chamber is triangular in cross section and a plurality of reagent steps are disposed along each triangular face for indicating the pressure of a plurality of specific components of the fluid sample.

32. The system according to claim 1 further comprises at least one reagent strip at a bottom of the receptacle and visible therethrough.

33. A body fluid collecting, storage, transporting, and dispensing system comprising:
a body fluid collecting receptacle;
a body fluid expresser disposed in the receptacle; and
a handle supporting the receptacle in a fluid collection position, said handle including a fluid sample chamber in fluid communication with the receptacle to receive a sample of the body fluid, said handle being removable from the receptacle for storage, transport and dispensing of the body fluid sample.

34. The system according to claim 33 wherein the receptacle includes a V-shaped cross sectional bottom and the system further comprises a separator disposed between the expresser and the receptacle bottom.

35. The system according to claim 34 wherein said expresser includes spaced apart flanges fixed to an inside wall of the receptacle and include a gap therebetween sized for blood squeezing engagement with an umbilical cord.

36. The system according to claim 35 wherein said handle comprises a plurality of fluid sample chambers each receives a sample of the body fluid.
